(19) United States
(12) Patent Application Publication
(10) Pub. No.: US 2009/0001028 A1
(43) Pub. Date: Jan. 1, 2009

(54) Two-stage oxygenation system for use with a fluidized bed reactor

(76) Inventors: Samuel Frisch, Manalapan, NJ (US); Paul Togna, Allentown, NJ (US); Douglas W. Watt, Hamilton Square, NJ (US); Michael Arthur Del Vecchio, Flemington, NJ (US)

Correspondence Address: RATNERPRESTIA, P.O. BOX 980, VALLEY FORGE, PA, 19482, US

(21) Appl. No.: 11/823,205

(22) Filed: Jun. 27, 2007

(51) Int. Cl. B01D 24/36; B01D 35/14; C02F 1/72

(52) U.S. Cl. 210/758; 210/274; 210/86

(57) ABSTRACT

A two-stage oxygenation system for use with a fluidized bed reactor is provided. The oxygenation system includes an oxygenation vessel coupled to receive oxygen from a source of oxygen, and a separator vessel coupled to receive feed from a source of feed. The separator vessel is coupled to receive recovered oxygen from the oxygenation vessel and recycle from the fluidized bed reactor. The oxygenation vessel is coupled to receive feed and recycle from the separator and to discharge oxygenated feed and recycle for delivery to the fluidized bed reactor and the recovered oxygen for delivery to the separator vessel.

### BACKGROUND OF THE INVENTION

Biological reactors find increasing use in many areas of industry, including waste treatment plants. Efforts to protect the environment include advanced biological treatment of wastewater through the use of biological reactors, and in particular, fluidized-bed bioreactors. It is the activity of biologically active materials (or “biomass”) within the biological reactor that degrades contaminants in the influent to effect a filtration process. As the biomass treats, through enzymatic reaction, these contaminants, the biomass grows through reproduction within the system. Typically, this activity occurs within a treatment vessel which contains media or other substrate material or carriers on which the biomass attaches and grows as contaminants are consumed. Typical media would include plastic beads, resin beads, sand, activated carbon, or ion exchange resins, among other carriers.

Highly loaded aerobic fluidized bed reactor (FBR) systems are characterized by thick biofilms and high oxygen demand. Thick films cause media to become more buoyant and therefore, media carryover is of concern. Additionally, high rates or excessive rates of oxygen feed upstream of an FBR may result in free gas carryover or de-supersaturation within the liquid entering the FBR. Turbulence caused by free gas in an FBR can also greatly contribute to media carryover. To address the media carryover potential in highly loaded FBR systems, a media separator vessel is typically used to recover media carried over in the FBR recycle and/or effluent lines.

Conventional FBR systems suffer from operational drawbacks in that the fluidized bed may be subject to inadequate oxygenation. More specifically, operation of aerobic bioreactor systems under high rate loading conditions can result in an oxygen limitation. In other words, treatment capacity is limited by the amount of oxygen that can be dissolved into the bioreactor system. FBR systems that use an enriched oxygen source (i.e., 90-100% pure oxygen, typically 90-95% oxygen concentration that is generated by a pressure swing adsorption system) are limited in the amount of oxygen that can be dissolved into the water per pass of water through the oxygenation system. This limitation is based on the solubility of oxygen (at the pressure and temperature), and the efficiency of the oxygen dissolution system. The oxygenation capacity of FBR systems is generally proportional to the fluidization flow (typically 10-13 gpm/sq. ft. of FBR cross-sectional area) and the oxygenation vessel pressure.

Increasing fluidization flow requires a larger diameter FBR vessel and fluidization pump. Increasing oxygenation vessel pressure beyond approximately 25 psig can cause several operating problems, including cavitation and release of excessive volumes of supersaturated gas as pressure is reduced across the fluidization flow control valve. Release of supersaturated gas can cause turbulent bubbling within the FBR resulting in excessive biomass stripping from the media and media carryover.

Either increasing the FBR vessel diameter or the oxygenation vessel pressure can cause significant increases in capital and operating costs. Accordingly, there remains a need in the industry for a system with improved oxygenation, i.e., greater oxygenation capacity and efficiency.

### SUMMARY OF THE INVENTION

In an exemplary embodiment, this invention provides a two-stage oxygenation system for use with a fluidized bed reactor. The oxygenation system includes an oxygenation vessel, also referred to as a bubble column, coupled to receive oxygen from a source of oxygen, and a separator vessel coupled to receive feed from a source of feed. The separator vessel is coupled to receive recovered oxygen from the oxygenation vessel and recycle from the fluidized bed reactor. The oxygenation vessel is coupled to receive feed and recycle from the separator and to discharge oxygenated feed and recycle for delivery to the fluidized bed reactor and the recovered oxygen for delivery to the separator vessel.

### BRIEF DESCRIPTION OF THE DRAWINGS

FIG. 1 is a block diagram of an embodiment of a two-stage oxygenation system according to this invention;

FIG. 2 is a schematic diagram of the system represented in FIG. 1;

FIG. 3 is a front view of an embodiment of an oxygenation vessel adapted for use within the system represented in FIG. 1; and

FIG. 4 is a plan view of a portion of an embodiment of a fluidized bed reactor vessel with a submerged orifice collector mounted therein.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Referring to the figures generally, an exemplary embodiment of a two-stage oxygenation system 10 for use with a fluidized bed reactor 12 is provided. The oxygenation system 10 includes an oxygenation vessel 14 coupled to receive oxygen O from a source of oxygen, and a separator vessel 16 coupled to receive feed F from a source of feed. The separator vessel 16 is coupled to receive recovered oxygen RO from the oxygenation vessel 14 and recycle R12 from the fluidized bed reactor 12. The oxygenation vessel 14 is coupled to receive feed and recycle FR16 from the separator 16 and to discharge oxygenated feed and recycle FR14 for delivery to the fluidized bed reactor 12 and the recovered oxygen RO for delivery to the separator vessel 16.

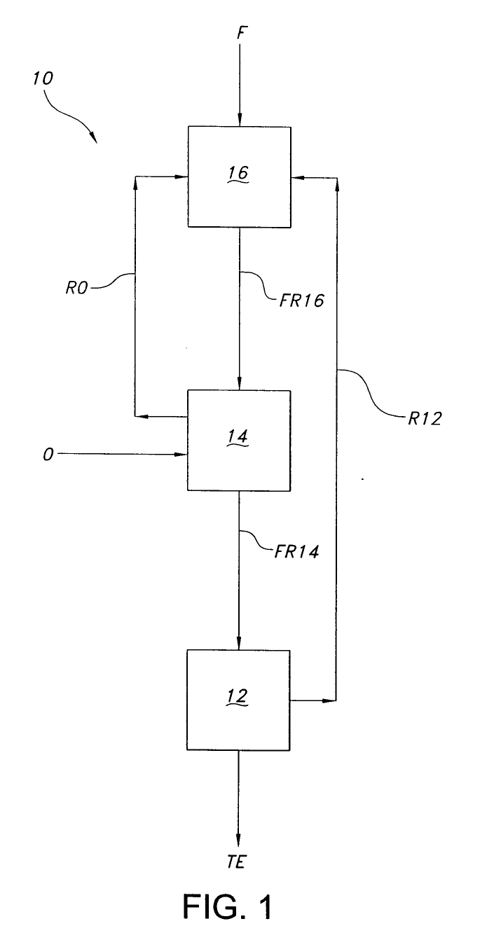

Referring now to FIG. 1, a block diagram of an embodiment of a two-stage oxygenation system 10 for use with a fluidized bed reactor 12 is shown. More specifically, the oxygenation system 10 includes an oxygenation vessel 14 (which forms a second stage of the oxygenation system 10) coupled to receive oxygen O from a source of oxygen. A separator such as a centrifugal separator vessel 16 (which forms a first stage of the oxygenation system 10) is coupled to receive feed F from a source of feed. The separator vessel 16 is coupled to receive recovered oxygen RO from the oxygenation vessel 14 and recycle R12 from the fluidized bed reactor 12. The oxygenation vessel 14 is coupled to receive feed and recycle FR16 from the separator 16 and to discharge oxygenated feed and recycle FR14 for delivery to the fluidized bed reactor 12 and the recovered oxygen RO for delivery to the separator vessel 16. Treated effluent TE is discharged from the fluidized bed reactor 12.

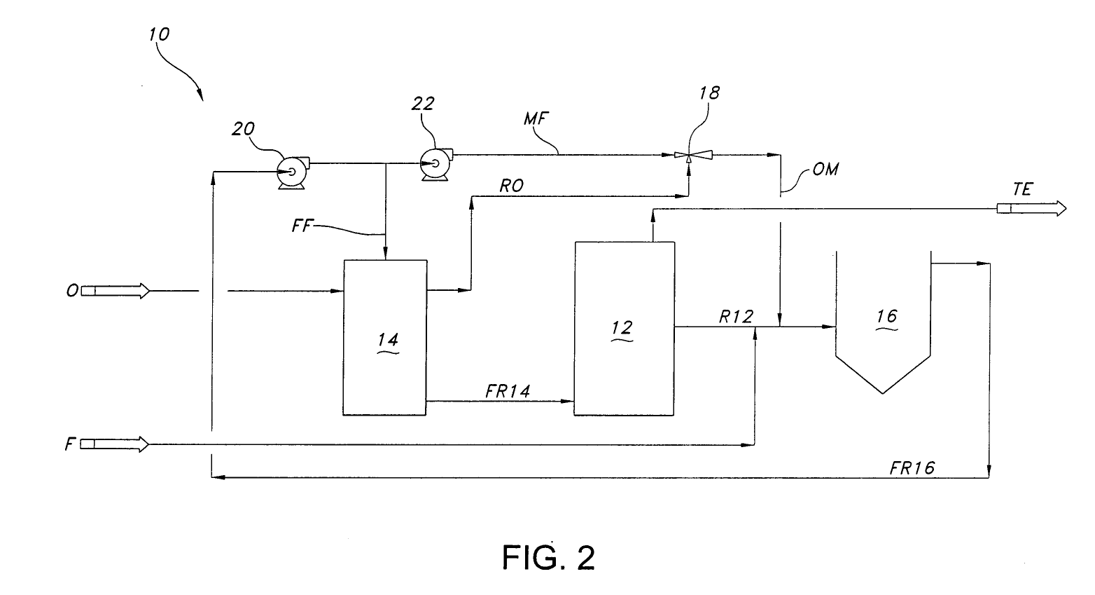

FIG. 2 is a schematic diagram of the system 10 represented in FIG. 1. The centrifugal separator vessel 16, which forms the first stage of the oxygenation system 10, is coupled to receive feed F from a source of feed. The separator vessel 16 is also coupled to receive recovered oxygen RO from the oxygenation vessel 14. The recovered oxygen RO is delivered by means of a coiled tube, the length of which may be adjusted by increasing or decreasing the number of coils to control the flow. The recovered oxygen RO delivered from the oxygenation vessel 14 is recycled for oxygenation in the first stage 16 of the oxygenation system 10. More specifically, the recovered oxygen RO from the oxygenation vessel 14 flows through a first-stage oxygen eductor 18. The eductor 18 provides a source of fine bubbles. The first-stage oxygen eductor 18 is configured to receive a portion of the oxygenated feed and recycle FR16 from the first stage 16 of the oxygenation system 10 and the recovered oxygen RO from the oxygenation vessel 14, and to discharge an oxygenated mixture OM.

The recovered oxygen stream RO is motivated by the difference in pressure between the top of the oxygenation vessel 14 (typically 15-25 psi) and the entrance to the first-stage oxygen eductor 18 (typically 0 psi by design). The flow rate will depend on the length and size of the conveying tube and on the gas ratio in the recovered oxygen stream RO. The conveying tube may be coiled and its length may be trimmed on-site, as necessary, based upon considerations of oxygen flow conservation and required efficiency.

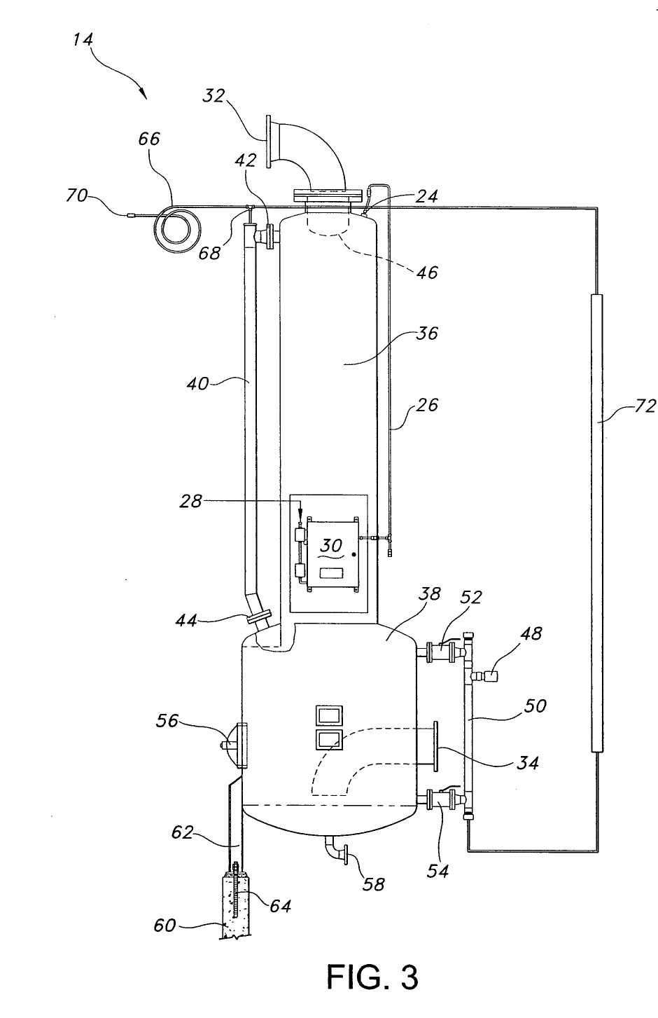

FIG. 3 illustrates a detailed view of the oxygenation vessel 14. The oxygenation vessel 14 is coupled to receive oxygen O at inlet 24 via an oxygen feed tubing assembly 26. Oxygen feed 28 is controlled by an oxygen control assembly 30. The oxygenation vessel 14 is coupled to receive preoxygenated feed and recycle liquids FR16 from the separator 16 at inlet 32 and to discharge oxygenated feed and recycle FR14 at outlet 34 for delivery to the fluidized bed reactor 12.

The oxygenation vessel 14 includes an upper dissolution section 36 for downflow dissolution of oxygen-rich bubbles into the feed and recycle stream FR14 and a lower disengagement section 38 where reduced velocity causes undissolved (free) gas to float for recovery via an oxygenation vessel gas return or recycle pipe 40. The oxygenation vessel gas return or recycle pipe 40 includes a recycle gas inlet 44 and a recycle gas exit 42. Attached to the oxygenation vessel gas return or recycle pipe 40 is a recovered gas coiled tube 66 including an inlet 68 and an outlet 70. The gas discharged from the outlet 70 is the recovered oxygen RO discharged from the oxygenation vessel 14 for delivery to the separator vessel 16. The tube 66 is of an adjustable length. The diameter of the tube 66 is selected in combination with the length of the tube 66 for the desired gas flow adjustment.

A feed and recycle distribution nozzle 46 is a spray nozzle that produces a multitude of water streams. The resulting turbulence entrains gas and creates a bubble swarm that flows down slowly. Bubbles are acted upon by an upward buoyant force and a downward force from the liquid flow. By design, the liquid superficial velocity is about 0.5-1.0 feet/second resulting in a net downward force that causes the bubbles to move down more slowly than the liquid. Slow movement of the bubbles provides greater time for dissolution.

At the lower disengagement section 38, a level switch 48 mounted on a level switch standpipe 50 provides system protection. More specifically, the level switch 48 prevents free (undissolved) gas from entering the fluidized bed reactor 12. The level switch 48 protects against an over-accumulation of gas in the lower disengagement section 38. Detection of gas in the lower disengagement section 38 disables oxygen feed 28 through the oxygen control assembly 30. The level switch standpipe 50 includes isolation valves 52, 54 for use during servicing of the level switch 48. The lower disengagement section 38 further includes an inspection opening 56 and a drain 58 for use as necessary.

The oxygenation vessel 14 is mounted to a concrete base 60 by at least one leg 62 via an anchor rod 64.

Referring back to FIG. 2, the separator vessel 16 is also coupled to receive recycle R12 from the fluidized bed reactor 12. The feed F from a source of feed, the oxygenated mixture OM (oxygenated feed and recycle FR16 from the first stage 16 of the oxygenation system 10 and the recovered oxygen RO from the oxygenation vessel 14), and the recycle R12 from the fluidized bed reactor 12 are mixed together prior to entering the separator vessel 16. Treated effluent TE is discharged from the fluidized bed reactor 12.

The oxygenation vessel 14, which forms the second stage 14 of the oxygenation system 10, is coupled to receive high purity oxygen O from a source of oxygen 28. The source of oxygen 28 may be a pressure swing absorption unit, a local oxygen storage system, or any other source of high purity oxygen. The oxygenation vessel 14 is also coupled to receive a portion of feed and recycle FR16 from the separator 16. The feed and recycle FR16 from the separator 16 flows through a fluidized bed reactor fluidization pump 20. The fluidized bed reactor fluidization pump 20 typically handles a flow of feed and recycle FR16 that is equivalent to 10-13 gallons per minute per square foot of the cross sectional area of the fluidized bed reactor 12. The fluidized bed reactor fluidization pump 20 is positioned to urge feed and recycle FR16 delivered from the separator vessel 16 toward the oxygenation vessel 14. More specifically, the fluidized bed reactor fluidization pump 20 delivers a portion (about 170 gallons per minute) of the oxygenated feed and recycle FR16 from the separator vessel 16 to the oxygenation vessel 14, and delivers another portion (about 100 gallons per minute) of the oxygenated feed and recycle FR16 from the separator vessel 16 toward the first-stage oxygen eductor 18. The portion of the oxygenated feed and recycle FR16 delivered to the oxygenation vessel 14 is referred to as fluidized bed reactor fluidization flow FF. The fluidized bed reactor fluidization pump 20 handles fluidized bed reactor fluidization flow FF and motive flow MF. An optional oxygenation motive pump 22 is configured to deliver motive flow MF to the first-stage oxygen eductor 18, and may be utilized to boost the pressure of the stream of motive flow MF, if required.

The oxygenation motive pump 22 and the first-stage oxygen eductor 18 produce fine bubbles in the oxygenated mixture stream OM, and further produce fine bubbles as the oxygenated mixture stream OM is blended with recycle R12 and enters the separator vessel 16. The fine bubbles of depleted oxygen provide the oxygen source for the first stage of the oxygenation system 10 (centrifugal separator vessel 16).

The oxygenation vessel 14 is also coupled to discharge oxygenated feed and recycle FR14 for delivery to the fluidized bed reactor 12 and the recovered oxygen RO for delivery to the first-stage oxygen eductor 18. The eductor motive flow MF and the recovered oxygen RO are discharged from the first-stage oxygen eductor 18 as the oxygenated mixture OM to the separator vessel 16.

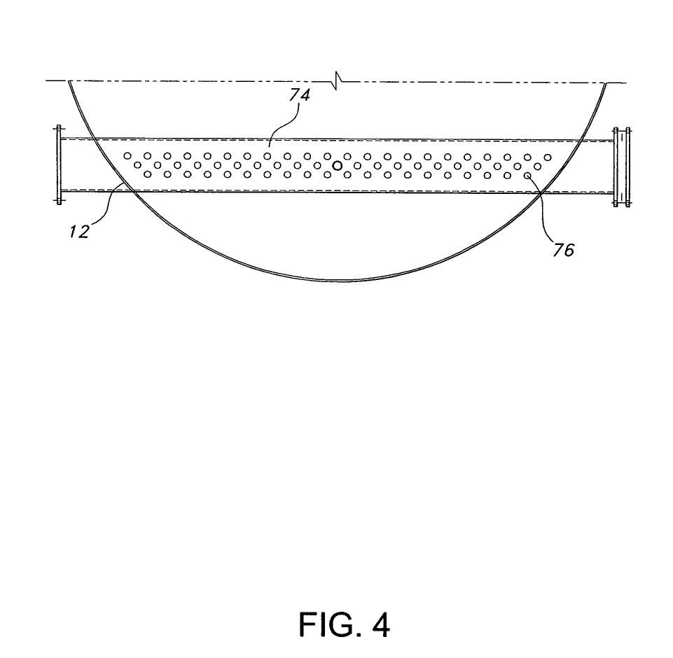

The fluidized bed reactor vessel 12 includes a submerged orifice collector 74, as illustrated in FIG. 4. FIG. 4 is a plan view illustrating the submerged orifice collector mounted within a portion of the fluidized bed reactor vessel 12. The submerged orifice collector is configured to collect recycle from the fluidized bed reactor vessel 12. The fluidized bed reactor vessel 12 may contain one, two, or more submerged orifice collectors 74, depending upon its size. The elevation of the submerged orifice collector 74 is typically about 18 inches below the fluid level in the fluidized bed reactor vessel 12. The submerged orifice collector achieves a more uniform collection than that which would be realized with a nozzle. More specifically, the submerged orifice collector is a cylindrical pipe with holes 76 along its top surface. The configuration of the holes 76 results in a pressure drop that achieves a more uniform collection of recycle R12. The recycle R12 collected by the submerged orifice collector 74 is discharged from the fluidized bed reactor 12 and then mixed together with the feed F from a source of feed and the oxygenation mixture OM (oxygenated feed and recycle FR16 from the first stage 16 of the oxygenation system 10 and the recovered oxygen RO from the oxygenation vessel 14) prior to entering the separator vessel 16.

As described above, the oxygenation vessel 14, which forms the second stage of the oxygenation system 10, is coupled to receive oxygen O from a source of high purity oxygen, and fluidized bed reactor fluidization flow FF. The oxygenation vessel 14 is configured to contain bubbles in the oxygenated fluidized bed reactor fluidization flow FF that move downwardly at a slower rate than liquid in the oxygenated fluidized bed reactor fluidization flow FF, thereby increasing the residence time of the bubbles within the oxygenation vessel 14, i.e., maximizing the exposure of liquid to oxygen. The oxygenation vessel 14 optionally includes an accessory level gauge 72 to indicate the quantity of gas in the oxygenation vessel 14. The accessory level gauge 72 provides an indication of the capacity of the oxygenation system 10. More specifically, if the liquid/gas interface is relatively high, there is relatively less recovered oxygen RO discharged from the oxygenation vessel 14 for delivery to the separator vessel 16. Conversely, if the liquid/gas interface is relatively low, there is relatively more recovered oxygen RO discharged from the oxygenation vessel 14 for delivery to the separator vessel 16. To achieve a properly balanced oxygenation system 10, the resistance in the recovered gas coiled tube 66 that discharges recovered oxygen RO from the oxygenation vessel 14 should be optimized. The optimized balance is to deliver a sufficient amount of gas to the first stage 16 of the oxygenation system 10 (without overfilling) while not permitting a free-flow of gas resulting in wasted oxygen.

The following values are applicable to a fluidized bed reactor 12 with a diameter equal to about 14 feet, and are provided by way of example only. Numerous variations, changes, and substitutions are contemplated. The flow of feed F that is delivered to the oxygenation system 10 from a source of feed is variable, as is the flow of treated effluent TE that is discharged from the fluidized bed reactor 12. The rates of these two variable flows (F and TE) are equal and, in the instant example, that variable value is X. Treated effluent TE is discharged from the fluidized bed reactor 12 at a rate of about X gallons per minute. The feed F from a source of feed (about X gallons per minute), the oxygenated mixture OM (about 170 gallons per minute), and the recycle R12 from the fluidized bed reactor 12 (about 2000−TE=about 2000−X gallons per minute) are mixed together prior to entering the separator vessel 16 at a combined rate of about 2170 gallons per minute. Treated effluent TE is discharged from the fluidized bed reactor 12 at about X gallons per minute. The fluidized bed reactor fluidization pump 20 typically handles about 2170 gallons per minute of the feed and recycle FR16. The fluidized bed reactor fluidization pump 20 delivers a portion (about 2000 gallons per minute) of the oxygenated feed and recycle FR16 from the separator vessel 16 to the oxygenation vessel 14, and delivers another portion (about 170 gallons per minute) of the oxygenated feed and recycle FR16 from the separator vessel 16 toward the first-stage oxygen eductor 18. The optional oxygenation motive pump 22 is configured to deliver the motive flow MF (about 170 gallons per minute) to the first-stage oxygen eductor 18, and may be utilized to boost the pressure of the stream of motive flow MF, if required. The oxygenation vessel 14 is also coupled to discharge oxygenated feed and recycle FR14 at a rate of about 2000 gallons per minute for delivery to the fluidized bed reactor 12 and the recovered oxygen RO at a rate of about 0.25 gallons per minute for delivery to the first-stage oxygen eductor 18. As explained above, the eductor motive flow MF (about 170 gallons per minute) and the recovered oxygen RO (about 0.25 gallons per minute) are discharged from the first-stage oxygen eductor 18 as the oxygenated mixture OM at a rate of about 170.25 gallons per minute to the separator vessel 16. Due to inherent system pressure losses, and because these values are approximate and this is merely an example of the numerous possible variations, changes, and substitutions, for simplicity the rate of flow of the oxygenated mixture OM was rounded down to 170 gallons per minute in the above-described example.

In use, a sample stream taken from the oxygenation vessel gas return or recycle pipe 40 of the oxygenation vessel 14 may contain no gas when the oxygen flow is relatively low (i.e. less than 50% of saturation at the operating pressure and temperature) and may contain an increasing fraction of gas as the oxygen demand is increased. This occurs naturally since the oxygenation vessel gas return or recycle pipe 40 recycles gas that has not dissolved in the vertical section of the oxygenation vessel 14. Therefore, use of this stream is self-controlling in regulation of the gas flow from the oxygenation vessel 14 to the separator vessel 16. Furthermore, the venting of the depleted gas from the oxygenation vessel 14 causes an enrichment of the average oxygen concentration in the oxygenation vessel 14.

In utilizing multiple aeration stages, the two-stage oxygenation system 10 results in greater oxygenation capacity and efficiency over conventional systems without increasing the bioreactor diameter or the oxygenation pressure. In the first stage, recycle R12 from fluidized bed reactor 12 is blended with feed and oxygenated mixture stream OM in the centrifugal separator vessel 16.

Use of a pre-oxygenation step (first stage) provides several key advantages. For example, recovery and reuse of the depleted oxygen (recovered oxygen RO) from the second stage of the oxygenation system 10 (oxygenation vessel 14) improves efficiency.

Another advantage of a pre-oxygenation step (first stage) is that the residence time in the centrifugal separator vessel 16 allows slower oxidation reactions to occur (such as iron oxidation, sulfide oxidation, and suspended growth bioactivity) prior to introducing the feed and recycle to the fluidized bed reactor 12. The oxygen demand of the fluidized bed reactor 12 is therefore proportionately reduced. Since the centrifugal separator vessel 16 is used as a multipurpose vessel, it does not require additional system tankage.

Yet another advantage of a pre-oxygenation step (first stage) is that since oxygen flows through the second stage oxygenation (the oxygenation vessel 14), a mass balance analysis indicates that the average oxygen concentration within the oxygenation vessel 14 is higher then it otherwise would be with the use of a single stage. The higher oxygen concentration in the oxygenation vessel 14 allows for greater dissolution efficiency at any given operating pressure (as proven by Henry's Law).

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A two-stage oxygenation system for use with a fluidized bed reactor, said oxygenation system comprising:
an oxygenation vessel coupled to receive oxygen from a source of oxygen; and
a separator vessel coupled to receive feed from a source of feed;
said separator vessel being coupled to receive recovered oxygen from said oxygenation vessel and recycle from the fluidized bed reactor; and
said oxygenation vessel being coupled to receive feed and recycle from said separator and to discharge oxygenated feed and recycle for delivery to the fluidized bed reactor and said recovered oxygen for delivery to said separator vessel.

2. The system of claim 1, wherein said separator vessel forms a first stage of said oxygenation system, and said oxygenation vessel forms a second stage of said oxygenation system.

3. The system of claim 2, wherein said recovered oxygen delivered from said oxygenation vessel is recycled for oxygenation in said first stage of said oxygenation system.

4. The system of claim 2 further comprising a first-stage eductor configured to receive a portion of said oxygenated feed and recycle from said first stage of said oxygenation system and said recovered oxygen from said oxygenation vessel, and to discharge an oxygenated mixture.

5. The system of claim 4 further comprising a fluidized bed reactor fluidization pump positioned to urge feed and recycle delivered from said separator vessel toward said first-stage eductor.

6. The system of claim 5, wherein said fluidized bed reactor fluidization pump delivers a portion of said oxygenated feed and recycle from said separator vessel to said oxygenation vessel, and delivers another portion of said oxygenated feed and recycle from said separator vessel toward said first-stage eductor.

7. The system of claim 4, further comprising an optional oxygenation motive pump configured to deliver motive flow to said first-stage eductor, wherein said motive pump increases the pressure of said motive flow.

8. The system of claim 4, wherein said first-stage eductor provides a source of fine bubbles.

9. The system of claim 1, wherein the fluidized bed reactor vessel comprises a submerged orifice collector.

10. The system of claim 9, wherein said submerged orifice collector is configured to collect recycle from said fluidized bed reactor vessel.

11. The system of claim 1 where said oxygenation vessel is configured to contain bubbles in said oxygenated recycle that move downwardly at a slower rate than liquid in said oxygenated recycle, thereby increasing the residence time of said bubbles within said oxygenation vessel.

12. The system of claim 11, wherein said oxygenation vessel optionally includes an accessory level gauge to indicate the quantity of gas in said oxygenation vessel.

13. The system of claim 1, wherein said separator comprises a centrifugal separator.

14. A fluidized bed reactor system comprising:
a fluidized bed reactor;
a separator vessel coupled to receive feed from a source of feed; and
an oxygenation vessel coupled to receive oxygen from a source of oxygen;
said separator vessel being coupled to receive recovered oxygen from said oxygenation vessel and recycle from said fluidized bed reactor; and
said oxygenation vessel being coupled to receive feed and recycle from said separator, to discharge oxygenated feed and recycle for delivery to said fluidized bed reactor, and to deliver said recovered oxygen to said separator vessel.

15. The system of claim 14, wherein said separator vessel forms a first stage of an oxygenation system, and said oxygenation vessel forms a second stage of said oxygenation system.

16. The system of claim 15 further comprising a first-stage eductor configured to receive oxygenated recycle from said first stage of said oxygenation system and said recovered oxygen from said oxygenation vessel, and to discharge an oxygenated mixture.

17. The system of claim 16 further comprising a fluidized bed reactor fluidization pump positioned to urge feed and recycle delivered from said separator vessel toward said oxygenation vessel and said first-stage eductor.

18. The system of claim 16, further comprising an optional oxygenation motive pump configured to deliver motive flow to said first-stage eductor, wherein said motive pump increases the pressure of said motive flow.

19. A method of oxygenating a fluidized bed reactor in a two-stage oxygenation process comprising the steps of:
delivering recovered oxygen from an oxygenation vessel to a separator vessel;
recycling substrate from the fluidized bed reactor to the separator vessel and from the separator vessel to the oxygenation vessel; and
discharging oxygenated substrate from the oxygenation vessel to the fluidized bed reactor.

20. The method of claim 19, said recycling step comprising delivering a portion of oxygenated recycle from the separator vessel to the oxygenation vessel and another portion of the oxygenated recycle from the separator vessel toward a first-stage eductor.
